(19) United States
(12) Patent Application Publication
(10) Pub. No.: US 2014/0316955 A1
(43) Pub. Date: Oct. 23, 2014

(54) Method for Automatic Testing of Tax Software

(71) Applicant: RYAN, LLC, Dallas, TX (US)

(72) Inventors: Mustafa Ashurex, Wilsonville, OR (US); Adrian Steller, London (GB)

(73) Assignee: RYAN, LLC, Dallas, TX (US)

(21) Appl. No.: 14/212,275

(22) Filed: Mar. 14, 2014

Related U.S. Application Data
(63) Continuation-in-part of application No. 13/369,131, filed on Feb. 8, 2012.
(60) Provisional application No. 61/788,814, filed on Mar. 15, 2013.
(60) Provisional application No. 61/448,075, filed on Mar. 1, 2011.
(60) Provisional application No. 61/498,361, filed on Jun. 17, 2011.

(51) Int. Cl. G06Q 40/00

(52) U.S. Cl. CPC G06Q 40/123
USPC 705/31

(57) ABSTRACT

Configurations of client specific taxable transactions are validated by inputting client initial transaction data to a test deck generating program which is executed to generate a client tax configuration test deck comprising the initial transaction data, assumed transaction data, and expected taxability of the initial transaction data and assumed transaction data. A tax determination program is executed using data from the client tax configuration test deck to generate simulated tax calculations. The simulated tax calculations are input to a configuration validation program to compare the simulated tax calculations with the expected taxability of the transaction data to identify defects. A report is generated identifying any defects.

### CROSS-REFERENCE TO RELATED APPLICATIONS

This application claims the benefit of U.S. Provisional Application No. 61/788,814 filed Mar. 15, 2013, and is also a continuation-in-part application of prior U.S. application Ser. No. 13/369,131 filed Feb. 8, 2012, which claims the benefit of both U.S. Provisional Application No. 61/448,075 filed Mar. 1, 2011, and 61/498,361 filed Jun. 17, 2011, all of which applications are hereby incorporated herein by reference, in their entirety.

### TECHNICAL FIELD OF THE INVENTION

The present invention relates generally to a method for automatically testing transaction tax data—typically for value added tax, goods and services tax, sales and use tax, etc. Specifically, the present invention relates to a highly configurable test engine for taxable transactions that may test any number of tax variables or factors without limitation.

### BACKGROUND OF THE INVENTION

Traditionally, business entities that generate revenue through commercial transactions are taxed by government entities that may vary by geographic location or jurisdiction. For businesses that have many different branches or locations in different tax jurisdictions, or conduct commercial transactions in various geographical locations, there may be many different tax liabilities.

Business entities may also have tax liabilities that are dependent on an array of many other factors such as: the type of business (e.g., a manufacturer, service entity, goods distributor, etc), the type of goods sold, the jurisdictions in which the business conducts its affairs, and the like. Thus, as part of the process for properly reporting and submitting taxes for commercial transactions and for avoiding civil or criminal tax penalties, such as monetary fines, the revocation of licenses, or even potential jail time for business officers involved, businesses must be able to correctly calculate and apply the correct tax result for each commercial transaction that they conduct.

To ensure accurate reporting of taxable transactions, businesses may utilize taxation software that calculates the appropriate tax liability per transaction. Because the incorrect or inaccurate reporting of taxable transactions may subject a business to tax liabilities, taxation software must be accurate in the calculation of tax liability, and must take into account many various factors such as: type of business, type of goods, location of the transaction, and the like. Many other factors may potentially affect tax liability, and it would be prudent for taxation and accounting software to take all such factors and variables into account when calculating tax. However, due to constantly changing tax rules, it is very difficult to correctly calculate the amount of tax without some errors or issues arising. Therefore, most users of taxation software will run extensive tests on various taxation scenarios before using the software for real world applications or production.

For example, a business may sell a product such as a computer monitor to a customer. The computer monitor may be classified as a consumer product or a business product depending on who the purchaser is, and how the computer monitor is to be used. Additional factors that may affect taxation of the monitor may be geographic, for instance between State A and State B in the United States, or between State A and Country C. This is an example how tax modifiers may affect the tax liability for a particular transaction. There are a large number of such factors to consider for many different taxable transactions, and larger businesses typically must account for hundreds or even thousands of taxation factors for the different types of goods and services purchased and sold.

Businesses typically perform simulations or tests of these real-world commercial transactions in order to appropriately calculate the correct amount of tax prior to the actual transaction taking place. These simulations or tests are typically performed by software programs which are run on electronic systems such as computers. The software programs may be given data values or variables from which to process information. These data values comprise a number of factors, such as discussed supra, namely, type of business, type of goods or services, location of the transaction, and many other factors that may be incorporated in the software simulations or tests. As with any processing system, however, if incorrect factors or data values are submitted to the tax software, incorrect values or results may be output.

The many different possible factors may result in tens of thousands of possible tests per geographic region, further adding to the difficulty of correctly simulating or testing the calculation of correct tax liability. A user of typical tax calculation software must manually edit and revise these factors, and this process is naturally time-consuming and prone to user input errors. Because of the amount of time required by a human user to manually setup the test deck, the overall number of simulations or tests that may be run within a specific time frame is severely limited. Without sufficient time to run all possible scenarios in the test deck, a company may be forced to run a sample of only the most frequently encountered scenarios in a commercial transaction scenario. Furthermore, many current taxation testing software have restrictions with regard to the factors that it may accept for testing purposes. For instance, these restrictions may limit the number of factors that the program may accept at any one time for testing, or they may restrict the types of acceptable factors that may be loaded into the taxation testing software as data values. These various limitations may leave a business exposed to various scenarios which could result in additional tax liabilities and/or government imposed tax penalties or sanctions.

Thus, a need exists for a method of automatically scripting and testing various tax scenarios that is accurate, repeatable, and capable of being implemented in an automated fashion, e.g., by use of a computer. Further, a need exists for a method of automatically testing different tax scenarios that is able to accept a wide number and variety of data factors in order to more accurately test all possible tax scenarios.

### SUMMARY OF THE INVENTION

It is therefore a general object of the present invention to provide an improved method of testing that automates the testing process. It is another object of the present invention to provide a method of testing that results in less auditing of tax transactions, after the transactions have occurred.

A method of validating configurations of client specific taxable transactions is disclosed, whereby data is input to a test deck generating program. The test deck generating program is run to generate a client tax configuration test deck comprising the initial transaction data, assumed transaction data, and expected taxability (i.e., in which jurisdiction(s) and at which rate(s)) of the initial transaction data and assumed transaction data. The tax determination program is run using data from the client tax configuration test deck to generate simulated tax calculations. The simulated tax calculations are input to a configuration validation program to compare the simulated tax calculations with the expected taxability of the transaction data to identify defects. A report is generated identifying any defects for analysis and resolution.

In an alternative embodiment, a method for automatically testing tax transactions includes a preliminary setup procedure which comprises the steps of creating a series of test decks so that a test engine is able to compare expected tax results with the actual results from the test engine. A test deck is a set of data values representing different user selected factors that must be accounted for during the test. Factors will generally correlate to real world variables that may affect a company's tax liability based on the type of taxable transactions performed. The factors may represent rules or other government imposed laws. The factors may also represent non-legal information such as the type of product being transacted, seller information, buyer information, price, geographic information, and many other possible information. The test deck may be manually created by a user, or may be generated by other software programs. The test deck may be stored on a computer readable medium in order for the test program to read and make use of the data values representing the different selected factors. The test deck is not limited to preset conditions, but may contain a highly modifiable number of variables that are user selectable.

Once preliminary setup procedures are complete, the test deck is imported to the automated taxation testing engine. This test engine may then be run manually by a user or may begin processing the test deck automatically to generate tax simulation results. When the test engine has completed all test cases and scenarios specified in the test deck, the generated simulation results are saved for analysis. The test engine may then compare the test results generated by the test engine with expected test results based on the tax rules specified. The test engine may flag any generated results that do not match the expected results for further analysis. Using the flags or other notifications provided by the test engine, a user may determine the errors in the test deck, and take appropriate corrective action.

In one embodiment of the present invention, the test engine will automatically generate and run the tests setup by the user without further intervention.

In another embodiment of the present invention, the test engine is able to test many different possible test scenarios without limitation.

In yet another embodiment of the present invention, the test engine will automatically flag exceptions, errors or other issues that may arise during the testing process.

In still another embodiment of the present invention, the test engine will check and ensure that the test deck correctly and accurately considers test factors that are unsuitable or inappropriate for the current test. These objectives are achieved as is now described.

One of the principal advantages of the exemplary embodiments is that it provides a highly effective and cost efficient method for testing large numbers of factors and running a great number of tax simulations on the test engine using those factors. Conventional tax engines are well known in the market but are only able to handle a limited quantity and quality of test factors. For instance, ONESOURCE® Indirect Tax Determination may only run tests for tax jurisdictions within the United States. ONESOURCE® Indirect Tax Determination is further limited in the amount of information it can display in its test results. Namely, ONESOURCE® Indirect Tax Determination can only flag results based on zero and non-zero values. ONESOURCE® Indirect Tax Determination and other conventional tax engines are therefore limited in their output capabilities and further unable to process a large number of transactions in a time and cost efficient manner. However, a principle advantage of the present invention is the ability to handle a great variety and number of test factors and utilize those factors in simulations run by the test engine. The present invention also provides the ability for the test engine to run a substantially greater number of simulations in the same amount of time as a conventional tax engine, such as ONESOURCE® Indirect Tax Determination, and the like.

Naturally, the invention will allow significant savings in the labor and time required to fully and accurately test all possible taxation scenarios. The invention will also allow for substantially decreased auditing and maintenance costs through its ability to automatically flag test results that contain errors or other important issues. The invention will additionally allow for significant savings by ensuring that all possible taxation scenarios are accounted for, and therefore a business is not susceptible to fines or penalties as a result of incorrectly reporting or submitting the proper tax amount to the collecting government entity.

As referred to hereinabove and throughout, the “present invention” refers to one or more exemplary embodiments of the present invention, which may or may not be claimed, and such references are not intended to limit the language of the claims, or to be used to construe the claims in a limiting manner.

### BRIEF DESCRIPTION OF THE DRAWINGS

The objects and features of the invention will become more readily understood from the following detailed description and appended claims when read in conjunction with the accompanying drawings in which like numerals represent like elements. The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a block diagram exemplifying hardware effective for implementing features of the present invention;

FIG. 2 is a flow chart exemplifying control logic embodying features of the present invention for validating configurations of client specific taxable transactions;

FIG. 3 is a flow chart exemplifying control logic embodying features of the present invention for inputting client initial transaction data to a test deck generating program;

FIG. 4 is a flow chart exemplifying control logic embodying features of the present invention for executing the test deck generating program;

FIG. 5 is a flow chart exemplifying control logic embodying features of the present invention for generating a client tax configuration extended test deck;

FIG. 6 is a flow chart exemplifying control logic embodying features of the present invention for executing a test deck extending program; and

FIG. 7 is a flow chart exemplifying control logic embodying features of the present invention for generating a client tax configuration extended test deck.

### DETAILED DESCRIPTION OF THE PREFERRED EMBODIMENTS

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein. As used herein, “substantially” is to be construed as a term of approximation.

It is noted that, unless indicated otherwise, all functions described herein may be performed by a processor such as a microprocessor, a controller, a microcontroller, an application-specific integrated circuit (ASIC), an electronic data processor, a computer, or the like, in accordance with code, such as program code, software, integrated circuits, and/or the like that are coded to perform such functions. Furthermore, it is considered that the design, development, and implementation details of all such code would be apparent to a person having ordinary skill in the art based upon a review of the present description of the invention.

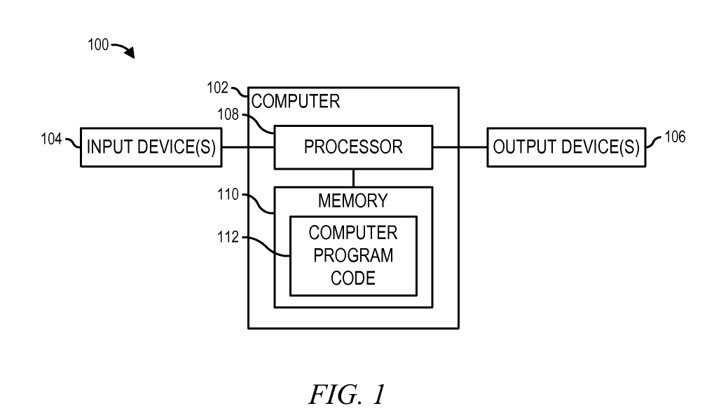

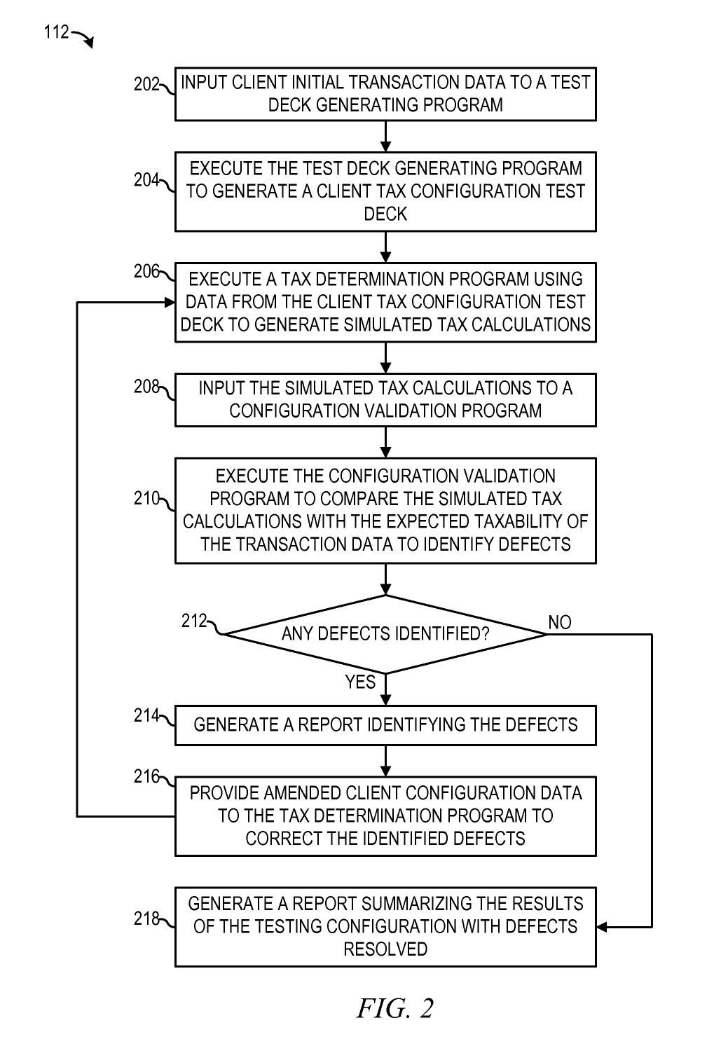

Referring to FIG. 1 of the drawings, the reference numeral 100 generally designates a computer system effective for implementing features of the present invention. The system 100 includes a computer 102 coupled to one or more input devices (e.g., keyboard, mouse, and the like) 104 and one or more output devices (e.g., display, printer, and the like) 106. The computer 102 preferably includes at least a processor 108 and memory 110. The memory 110 is effective for storing computer program code 112 executable by the processor 108 for performing features of the invention. The computer program code 112 is preferably effective for executing steps described in further detail below with respect to FIGS. 2-7.

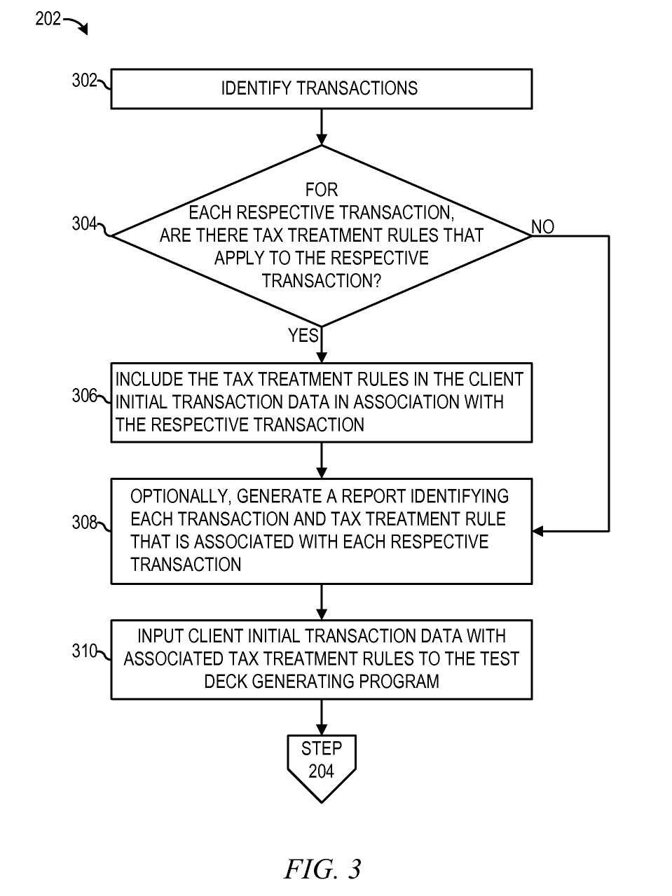

FIG. 2 is a flow chart of preferred control logic for validating configurations of client specific taxable transactions according to principles of the present invention. Accordingly, in step 202, client “initial transaction data” is entered to a test deck generating program. The “initial transaction data” preferably includes information about the client's legal entities (e.g., tax obligations), customers with whom they deal (e.g., a business, a consumer, or both), goods and broad categories of services purchased and sold, terms of trade, geographic sales and purchases (e.g., inter-company (e.g., between affiliated companies or companies within the same corporate group) and external purchases (e.g., between unaffiliated companies or companies outside the corporate group)). Initial transaction data may also include tax location (physical or legal), tax registration, location of customers and/or vendors, the nature of supply and/or purchases, a point of title transfer (for goods), vendor establishment status, customer establishment status, and the like. The initial transaction data may be entered in any of a number of different ways, such as by manual keyboard entry by a person after an interview with a client, or it may be automated using forms provided on commercially available software, or it may be exported from one program or database to the test deck generating program. As discussed in further detail with respect to FIG. 3, tax treatment rules may also be associated with each respective transaction.

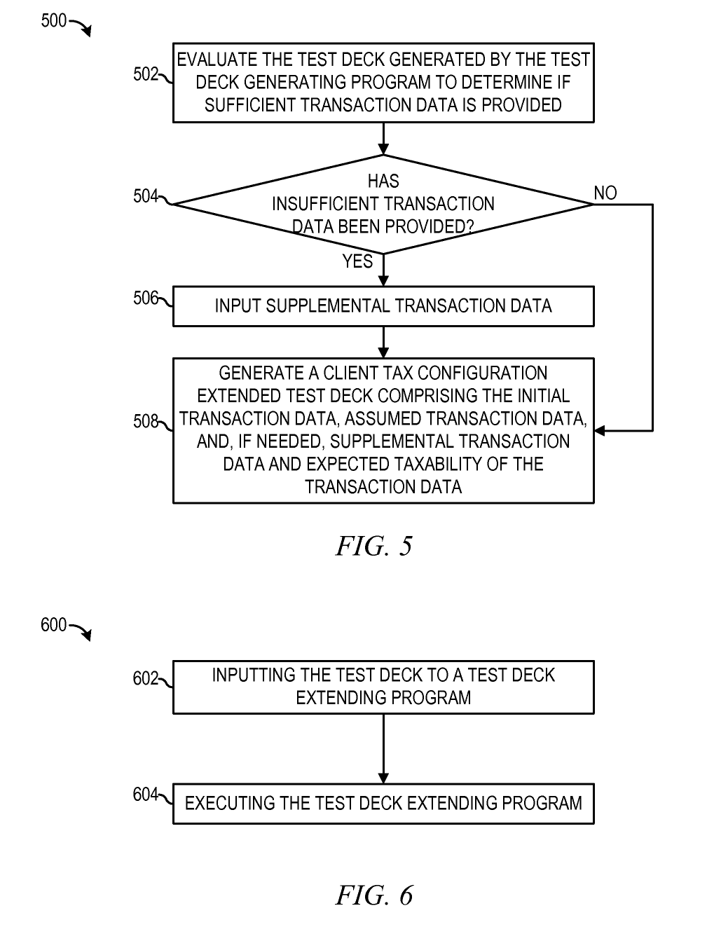

In step 204, the test deck generating program is executed to generate a client tax configuration test deck, as discussed in further detail below with respect to FIG. 5. The client tax configuration test deck is provided via a manual process to a tax determination program, such as ONESOURCE® Indirect Tax Determination, Vertex®, and Taxware®, which is required to execute programming code necessary to generate simulated tax calculations. The client tax configuration test deck is input to the tax determination program (e.g., ONESOURCE® Indirect Tax Determination). Steps 202 and 204 may optionally be combined and/or executed as a single step.

In step 206, the tax determination program is run to evaluate the information contained in the client tax configuration test deck's transactions to calculate tax, referred to herein as the “simulated tax calculations.” In step 208, the simulated tax calculations are input to a configuration validation program. In step 210, the configuration validation program is executed to compare, preferably at a relatively high level, the simulated tax calculations with the expected taxability (i.e., what can be taxed and at what rate) of the transaction data to identify defects (e.g., mismatches). Defects are preferably reviewed via a manual process to determine whether there is an error in the expected tax treatment or an error in the configuration of the tax determination program.

In step 212, a determination is made whether any defects were identified in step 210, and if any defects were identified, then execution proceeds to step 214; otherwise execution proceeds to step 218. In step 214, a report is preferably generated identifying the defects or mismatches. This is generally a manual step where defects are preferably reported using a template from a spreadsheet, such as Microsoft Excel®. In step 216, the client configuration data is amended to correct the defects, and is input to the tax determination program (e.g., ONESOURCE® Indirect Tax Determination). A consultant preferably analyzes the defects and seeks to determine for each defect whether it is an error in configuration, client data, input data format, or expected results. Execution then returns to step 206.

In step 218, a report is generated summarizing the results of the testing configuration with defects resolved. As errors are resolved, testing is re-run and reports are produced in step 214 that should show a declining error rate. The successive reports are used to illustrate error resolution via a declining error rate.

FIG. 3 exemplifies details of step 202 for inputting client initial transaction data to a test deck generating program. In step 302, client initial transactions are identified. In step 304, for each respective transaction, a determination is made whether there are any tax treatment rules that would apply to each respective transaction. Tax treatment rules may be predetermined or “hard-coded” (e.g., “All export transactions under EXW Incoterms are ‘zero-rated’”). Alternatively, a user may create or modify the rules needed where the rules vary. By way of example, but not limitation, if a client desires to apply a different tax treatment based on the way it does business, then tax treatment rules may be individually created or modified by a user (e.g., “EXW exports are ‘taxable’ rather than zero-rated”). Whereas with predetermined treatment rules that do not exactly fit a business, a user must override the treatment rules for each transaction, the ability to create or modify the rules needed enables a user to achieve the same result as overriding the treatment rules, but much more economically and reliably.

If it is determined in step 304 that there are any tax treatment rules that would apply to each respective transaction, execution proceeds to step 306; otherwise, execution proceeds to step 308. In step 306, the applicable tax treatment rule is associated with the appropriate respective client initial transaction. In step 308, a report identifying each transaction and tax treatment rule that is associated with each respective transaction may optionally be generated. In step 310, the client initial transaction data, with associated tax treatment rules, is input to the test deck generation program, and execution proceeds to step 204 of FIG. 2.

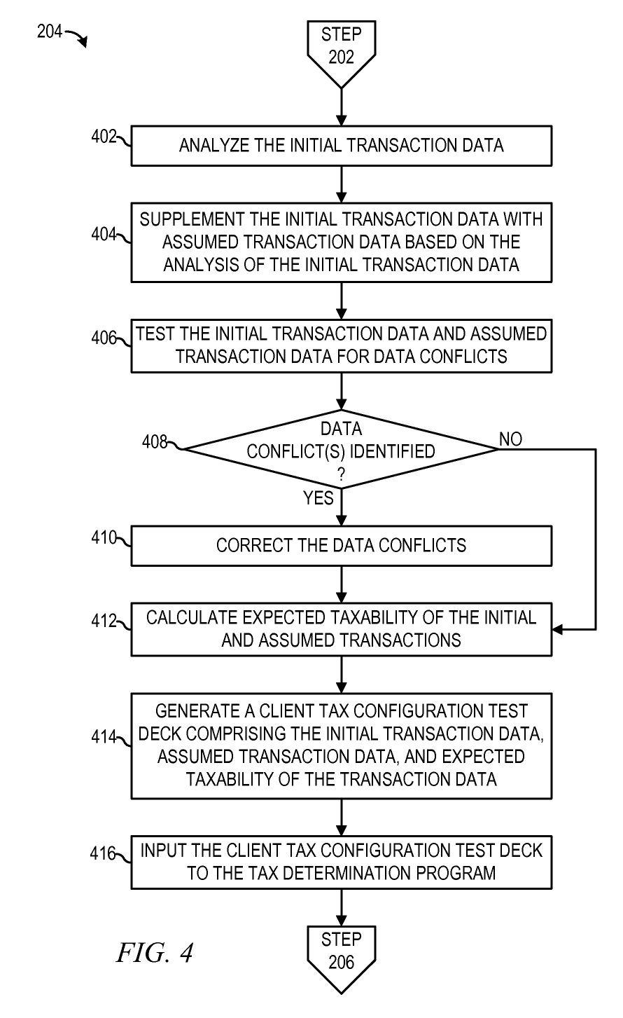

FIG. 4 depicts steps of execution of step 204 supra regarding execution of the test deck generating program. Following step 202 of FIG. 2, in step 402, the initial transaction data is analyzed, whereby a determination is made of which “scenarios” are applicable for testing. By way of example, if a client indicated that an entity does not export goods, then no “export” scenario would need to be generated in the test deck.

In step 404, the initial transaction data is supplemented with “assumed transaction data” based on the analysis of the initial transaction data in step 402. Assumed transaction data is generated by applying logic and general assumptions to information (e.g., the initial transaction data) provided by the client to determine, for example, whether entities supply goods or services, and then that determination constitutes and is included in the assumed transaction data. For example, if an entity was shown as selling goods inter-company, but not externally, this information could be evaluated to determine that supplies of goods will be relevant for inclusion in the assumed transaction data. In a further example, if an entity sells goods only cross-border, then assumed data would include only an export scenario, and not a domestic scenario. The operator of the test deck generating program can also determine the scope of the analysis, and the size of the transaction by selecting the scope of the variables input to the test deck generating program. The operator picks the variables and multiplies the initial scenario out to include a larger number of transactions.

In step 406, the initial transaction data and the assumed transaction data are preferably tested via a manual process for data conflicts. For example, if a client indicates that no cross-border services are supplied, but elsewhere they have indicated that they are an agent with an overseas principal, this information may be used to challenge the assertion that there are no cross-border supplies of services.

In step 408, a determination is made via a manual process whether any data conflicts (e.g., inclusion of cross-border supplies of services inter-company, discussed supra) are identified, and if so, then in step 410, a client is preferably asked about them and the data conflicts are corrected.

In step 412, the expected taxability of the initial transaction data and the assumed transaction data is calculated. Tax codes are automatically allocated to scenarios based on general rules. For example, a sale of goods in a country will typically be “standard rated” for tax purposes.

In step 414, a client tax configuration test deck is generated. The test deck preferably includes the initial transaction data, the assumed transaction data, and the expected taxability of the initial transaction data and the assumed transaction data.

In step 416, the client tax configuration test deck is input to the tax determination program. Execution then proceeds to step 206 of FIG. 2.

FIG. 5 depicts further steps that may be performed in connection with the process of FIGS. 2 and 3 discussed supra. In step 502, the test deck generated by the test deck generating program is evaluated to determine if sufficient transaction data is provided to the test deck generating program. This is based on knowledge of the client's configuration to determine relevant factors that need to be tested. By way of example, if a client only sells “standard-rated goods,” then there is limited value in testing a wide range of goods as the expectation would be that these will all return standard-rated results. In step 504, a determination is made whether insufficient transaction data has been provided to the test deck generating program, and if it has, then execution proceeds to step 506; otherwise, execution proceeds to step 508. At step 506, supplemental transactional data (e.g., product codes, order types, and different system parameters that are specific to a particular client that need to be tested, e.g., an order type that indicates that a product is free of charge) may optionally be input. The operator can select relevant parameters for each variable. For example, variables may include which products to include in tests, which countries to include, and the like. In step 508, a client tax configuration extended test deck comprising the initial transaction data, assumed transaction data, supplemental transaction data and expected taxability of the various transaction data is generated, and execution may proceed to step 206 (FIG. 2).

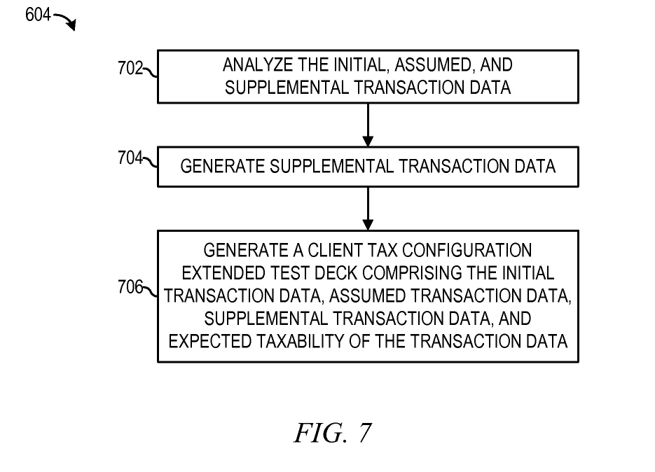

FIG. 6 depicts further steps that may be performed in connection with the process of FIGS. 2-4 discussed supra. In step 602, the test deck is input to the test deck extending program, or to a routine of the test deck generating program. In step 604, the test deck extending program is run, as discussed in further detail with respect to FIG. 7.

FIG. 7 depicts steps that may be performed in connection with step 604 of FIG. 6. In step 702, the initial transaction data, assumed transaction data, and supplemental transaction data are analyzed. In step 704, the supplemental transaction data is generated. In step 706, a client tax configuration extended test deck is generated comprising the initial transaction data, assumed transaction data, supplemental transaction data, and expected taxability of the initial transaction data, assumed transaction data, and supplemental transaction data. In a preferred embodiment, a “deck” comprises a series of decks that the user can create in order to achieve better performance when running it against the tax engine.

While the tax simulation method of the present invention is described in connection with an external tax determination program, such as ONESOURCE® Indirect Tax Determination, the method and its teachings are equally applicable in similarly complex sales and use tax compliance and research programs.

Having thus described the exemplary embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is contemplated that the appended claims will cover any such modifications or embodiments that fall within the true scope of the invention.

1. A system for validating configurations of client specific taxable transactions, the system comprising:
at least one computer having at least one processor;
at least one memory operably coupled to the at least one processor, the memory being configured for storing a computer program which, when executed by the processor, causes the processor to perform steps of:
inputting client initial transaction data to a test deck generating program, comprising steps of:
identifying transactions;
identifying, for each respective transaction, tax treatment rules that apply to the respective transaction; and
including the tax treatment rules in the client initial transaction data identified as applying to the respective transaction;
executing the test deck generating program to generate a client tax configuration test deck comprising steps of:
analyzing the initial transaction data;
supplementing the initial transaction data with assumed transaction data based on the analysis of the initial transaction data; and
calculating expected taxability of the initial transaction data and assumed transaction data with corrected data conflicts;
executing a tax determination program using data from the client tax configuration test deck to generate simulated tax calculations;
inputting the simulated tax calculations to a configuration validation program;
executing the configuration validation program to compare the simulated tax calculations with the expected taxability of the transaction data to identify defects;
inputting amended client initial transaction data to the test deck generating program, the amended client initial transaction data comprising client initial transaction data amended to correct the identified defects;
repeating the steps of executing the test deck generating program, executing the tax determination program, inputting the simulated tax calculations generated to a configuration validation program, and executing the configuration validation program, when defects are identified in the step of executing the configuration validation program; and
generating a report summarizing the results of the testing configuration with defects corrected.

2. The system of claim 1, wherein the tax treatment rules are predetermined.

3. The system of claim 1, wherein the tax treatment rules are created as needed.

4. The system of claim 1, wherein the tax treatment rules are modified as needed.

5. The system of claim 1, wherein client initial transaction data includes at least one of information relating to the client's legal entities, tax location, tax registration, location of customers and/or vendors, the nature of supply and/or purchases, a point of title transfer for goods, vendor establishment status, and customer establishment status.

6. The system of claim 1, wherein the step of executing the test deck generating program further comprises steps of:
testing the initial transaction data and assumed transaction data for data conflicts;
determining whether there are any data conflicts; and
upon a determination that there are data conflicts, correcting the data conflicts.

7. The system of claim 1, wherein execution of the computer program by the processor further causes the processor to perform steps of:
inputting the test deck to a test deck extending program; and
executing the test deck extending program, comprising the steps of:
analyzing the initial, assumed, and supplemental transaction data;
generating supplemental transaction data; and
generating a client tax configuration extended test deck comprising the initial transaction data, assumed transaction data, supplemental transaction data and expected taxability of the transaction data.

8. The system of claim 1, wherein the test deck comprises data values that correspond to user selected taxability factors, the data values including at least one of company name, transaction date, transaction type, transaction amount, terms, and ship-from and ship-to information.

9. The system of claim 1, wherein the test deck comprises data values that correspond to user selected taxability factors, the data values including at least one of company name, transaction date, transaction type, transaction amount, terms, and ship-from and ship-to information; the transaction type specifying goods or services and, for services, the category of service types; the terms for goods including when title transfers on cross-border transactions.

10. The system of claim 1, wherein execution of the computer program by the processor further causes the processor to perform a step of importing data values from an external tax determination program to the test deck.

11. The system of claim 1, wherein execution of the computer program by the processor further causes the processor to perform steps of saving and exporting into a computer-readable format the results of the simulated tax calculations.

12. A system for validating configurations of client specific taxable transactions, the system including a computer having at least a processor and a memory operably coupled to the processor, the memory being configured for storing a computer program which, when executed by the processor, causes the processor to perform steps of:
inputting client initial transaction data to a test deck generating program;
executing the test deck generating program to generate a client tax configuration test deck comprising the initial transaction data, assumed transaction data, and expected taxability of the initial transaction data and assumed transaction data;
executing a tax determination program using data from the client tax configuration test deck to generate simulated tax calculations;
inputting the simulated tax calculations to a configuration validation program;
executing the configuration validation program to compare the simulated tax calculations with the expected taxability of the transaction data to identify defects; and
generating a report identifying the defects.

13. The system of claim 12, wherein client initial transaction data includes at least one of information relating to the client's legal entities, tax location, tax registration, location of customers and/or vendors, the nature of supply and/or purchases, a point of title transfer for goods, vendor establishment status, and customer establishment status.

14. The system of claim 12, wherein execution of the computer program by the processor further causes the processor to perform steps of:
inputting amended client initial transaction data to the test deck generating program, the amended client initial transaction data comprising client initial transaction data amended to correct the identified defects;
executing the test deck generating program to generate an amended client tax configuration test deck comprising the initial transaction data, assumed transaction data, and expected taxability of the initial transaction data and assumed transaction data;
executing the tax determination program from the amended client tax configuration test deck to generate simulated tax calculations;
inputting the simulated tax calculations generated with defects corrected to a configuration validation program;
executing the configuration validation program to compare the simulated tax calculations with the expected taxability of the transaction data to identify defects; and
generating a report summarizing the results of the testing configuration with defects corrected.

15. The system of claim 12, wherein the step of inputting client initial transaction data to a test deck generating program further comprises steps of:
identifying transactions;
identifying, for each respective transaction, predetermined tax treatment rules that apply to the respective transaction;
including the predetermined tax treatment rules in the client initial transaction data identified as applying to the respective transaction; and
generating a report identifying each transaction and tax treatment rule that is associated with each respective transaction.

16. The system of claim 12, wherein the step of inputting client initial transaction data to a test deck generating program further comprises steps of:
identifying transactions;
identifying, for each respective transaction, tax treatment rules that apply to the respective transaction, wherein the tax treatment rules are created or modified as needed;
including the tax treatment rules in the client initial transaction data identified as applying to the respective transaction; and
generating a report identifying each transaction and tax treatment rule that is associated with each respective transaction.

17. The system of claim 12, wherein the step of executing the test deck generating program further comprises steps of:
analyzing the initial transaction data;
supplementing the initial transaction data with assumed transaction data based on the analysis of the initial transaction data; and
calculating expected taxability of the initial transaction data and assumed transaction data with corrected data conflicts.

18. The system of claim 12, wherein the step of executing the test deck generating program further comprises steps of:
analyzing the initial transaction data;
supplementing the initial transaction data with assumed transaction data based on the analysis of the initial transaction data;
testing the initial transaction data and assumed transaction data for data conflicts;
determining whether there are any data conflicts;
upon a determination that there are data conflicts, correcting the data conflicts; and
calculating expected taxability of the initial transaction data and assumed transaction data with corrected data conflicts.

19. The system of claim 12, wherein execution of the computer program by the processor further causes the processor to perform steps of:
inputting supplemental transaction data; and
generating a client tax configuration extended test deck comprising the initial transaction data, assumed transaction data, supplemental transaction data and expected taxability of the initial transaction data, assumed transaction data, and supplemental transaction data.

20. The system of claim 12, wherein execution of the computer program by the processor further causes the processor to perform steps of:
inputting the test deck to a test deck extending program; and
generating the test deck extending program, comprising the steps of:
analyzing the initial, assumed, and supplemental transaction data;
outputting supplemental transaction data; and
generating a client tax configuration extended test deck comprising the initial transaction data, assumed transaction data, and supplemental transaction data, and expected taxability of the transaction data, assumed transaction data, and supplemental transaction data.

21. The system of claim 12, wherein the test deck comprises data values that correspond to user selected taxability factors.

22. The system of claim 12, wherein the test deck comprises data values that correspond to user selected taxability factors, the data values including at least one of company name, transaction date, transaction type, transaction amount, terms, and ship-from and ship-to information.

23. The system of claim 12, wherein the test deck comprises data values that correspond to user selected taxability factors, the data values including at least one of company name, transaction date, transaction type, transaction amount, terms, and ship-from and ship-to information; the transaction type specifying goods or services and, for services, the category of service types; the terms for goods including when title transfers on cross-border transactions.

24. The system of claim 12, wherein execution of the computer program by the processor further causes the processor to perform steps of importing data values from an external tax determination program to the test deck.

25. The system of claim 12, wherein execution of the computer program by the processor further causes the processor to perform steps of saving and exporting into a computer-readable format the results of the simulated tax calculations.

26. A system for validating configurations of client specific taxable transactions, the system including a computer having at least a processor and a memory operably coupled to the processor, the memory being configured for storing a computer program which, when executed by the processor, causes the processor to perform steps of:
inputting client initial transaction data to a test deck generating program;
executing the test deck generating program to generate a client tax configuration test deck comprising the initial transaction data and expected taxability of the initial transaction data;
executing a tax determination program using data from the client tax configuration test deck to generate simulated tax calculations;
inputting the simulated tax calculations to a configuration validation program;
executing the configuration validation program to compare the simulated tax calculations with the expected taxability of the transaction data to identify defects; and
generating a report identifying the defects.

27. The system of claim 26, wherein client initial transaction data includes at least one of information relating to the client's legal entities, tax location, tax registration, location of customers and/or vendors, the nature of supply and/or purchases, a point of title transfer for goods, vendor establishment status, and customer establishment status.

28. The system of claim 26, wherein execution of the computer program by the processor further causes the processor to perform steps of:
inputting amended client initial transaction data to the test deck generating program, the amended client initial transaction data comprising client initial transaction data amended to correct the identified defects;
executing the test deck generating program to generate an amended client tax configuration test deck comprising the initial transaction data and expected taxability of the initial transaction data;
executing the tax determination program from the amended client tax configuration test deck to generate simulated tax calculations;
inputting the simulated tax calculations generated with defects corrected to a configuration validation program;
executing the configuration validation program to compare the simulated tax calculations with the expected taxability of the transaction data to identify defects; and
generating a report summarizing the results of the testing configuration with defects corrected.

29. The system of claim 26, wherein the step of inputting client initial transaction data to a test deck generating program further comprises steps of:
identifying transactions;
identifying, for each respective transaction, predetermined tax treatment rules that apply to the respective transaction; and
including the predetermined tax treatment rules in the client initial transaction data identified as applying to the respective transaction.

30. The system of claim 26, wherein the step of inputting client initial transaction data to a test deck generating program further comprises steps of:
identifying transactions;
identifying, for each respective transaction, tax treatment rules that apply to the respective transaction, wherein the tax treatment rules are created or modified as needed; and
including the tax treatment rules in the client initial transaction data identified as applying to the respective transaction.

31. The system of claim 26, wherein the step of inputting client initial transaction data to a test deck generating program further comprises steps of:
identifying transactions;
identifying, for each respective transaction, predetermined tax treatment rules that apply to the respective transaction;
including the predetermined tax treatment rules in the client initial transaction data identified as applying to the respective transaction; and
generating a report identifying each transaction and tax treatment rule that is associated with each respective transaction.

32. The system of claim 26, wherein the step of inputting client initial transaction data to a test deck generating program further comprises steps of:
identifying transactions;
identifying, for each respective transaction, tax treatment rules that apply to the respective transaction, wherein the tax treatment rules are created or modified as needed;
including the tax treatment rules in the client initial transaction data identified as applying to the respective transaction; and
generating a report identifying each transaction and tax treatment rule that is associated with each respective transaction.

33. The system of claim 26, wherein the step of executing the test deck generating program further comprises steps of:
analyzing the initial transaction data;
supplementing the initial transaction data with assumed transaction data based on the analysis of the initial transaction data; and
calculating expected taxability of the initial transaction data and assumed transaction data with corrected data conflicts.

34. The system of claim 26, wherein the step of executing the test deck generating program further comprises steps of:
analyzing the initial transaction data;
supplementing the initial transaction data with assumed transaction data based on the analysis of the initial transaction data;
testing the initial transaction data and assumed transaction data for data conflicts;
determining whether there are any data conflicts;
upon a determination that there are data conflicts, correcting the data conflicts; and
calculating expected taxability of the initial transaction data and assumed transaction data with corrected data conflicts.

35. The system of claim 26, wherein execution of the computer program by the processor further causes the processor to perform steps of:
inputting supplemental transaction data; and
generating a client tax configuration extended test deck comprising the initial transaction data and supplemental transaction data, and expected taxability of the initial transaction data and supplemental transaction data.

36. The system of claim 26, wherein execution of the computer program by the processor further causes the processor to perform steps of:
inputting the test deck to a test deck extending program; and
generating the test deck extending program, comprising the steps of:
analyzing the initial and supplemental transaction data;
outputting supplemental transaction data; and
generating a client tax configuration extended test deck comprising the initial transaction data and supplemental transaction data, and expected taxability of the transaction data and supplemental transaction data.

37. The system of claim 26, wherein the test deck comprises data values that correspond to user selected taxability factors.

38. The system of claim 26, wherein the test deck comprises data values that correspond to user selected taxability factors, the data values including at least one of company name, transaction date, transaction type, transaction amount, terms, and ship-from and ship-to information.

39. The system of claim 26, wherein the test deck comprises data values that correspond to user selected taxability factors, the data values including at least one of company name, transaction date, transaction type, transaction amount, terms, and ship-from and ship-to information; the transaction type specifying goods or services and, for services, the category of service types; the terms for goods including when title transfers on cross-border transactions.

40. The system of claim 26, wherein execution of the computer program by the processor further causes the processor to perform a step of importing data values from an external tax determination program to the test deck.

41. The system of claim 26, wherein execution of the computer program by the processor further causes the processor to perform steps of saving and exporting into a computer-readable format the results of the simulated tax calculations.
